(19) United States
(12) Patent Application Publication
(10) Pub. No.: US 2018/0164606 A1
(43) Pub. Date: Jun. 14, 2018

(54) VARIABLE FOCUS SPECTACLES AND METHOD OF DRIVING THE SAME

(71) Applicant: HANKUK UNIVERSITY OF FOREIGN STUDIES RESEARCH BUSINESS FOUNDATION, Gyeonggi-do (JP)

(72) Inventor: Chang-Uk Jung, Gyeonggi-do (KR)

(21) Appl. No.: 15/835,006

(22) Filed: Dec. 7, 2017

(30) Foreign Application Priority Data
Dec. 8, 2016 (KR) 10-2016-0167019

(51) Int. Cl. G02C 7/08; G02B 3/14; G02B 7/28; G02C 7/02; G02C 7/06

(52) U.S. Cl. CPC G02C 7/083; G02B 3/14; G02C 7/061; G02C 7/022; G02B 7/285

(57) ABSTRACT

The present disclosure provided are a variable focus spectacle and a method of driving the same methods. In accordance with an embodiment of the present disclosure, the variable focus spectacle includes a spectacle frame; a pair of lenses mounted on the spectacle frame, and having a plurality of refractive indexes that varies in sequential order by an applied voltage including at least two different power levels; and a refractive index adjuster for supplying the applied voltage to the pair of lenses, wherein the refractive indexes of the pair of lenses is varied at least twice per unit time according to the at least two different power levels.

### CROSS-REFERENCE TO RELATED APPLICATION

This application claims priority of Korean Patent Application No. 10-2016-0167019, filed on Dec. 8, 2016, in the KIPO (Korean Intellectual Property Office), the disclosure of which is incorporated herein entirely by reference.

### BACKGROUND OF THE INVENTION

### Field of the Invention

The present disclosure relates to a spectacle, and more particularly, to a variable focus spectacle and a method of driving the same.

### Description of the Related Art

Many people have been suffering from inconveniences with nearsightedness in which things in a long distance look blurred due to a condition of an eye where light is focused in front of, instead of on, the retina. In addition, as many people age, he or she has been suffering from inconveniences with farsightedness in which things in a short distance look blurred due to a condition of an eye where light focuses behind, instead of on, the retina. Due to such inconveniences, some people wear functional spectacles, such as reading spectacles, bifocal lens spectacles and progressive multifocal lens spectacles, depending on the purpose, or have a surgical operation such as LASIK or LASEK eye surgery to correct myopia and/or hyperopia.

Among them, the progressive multifocal lens is mainly used for correcting a deteriorating eyesight due to presbyopia. The progressive multifocal lens has a structure in which a thickness of the lens is partially different, and a power of spectacle gradually changes within single lens, thereby focusing on a corresponding object through the single lens from a long distance to a short distance. For example, the myopia may be corrected through the upper portion of the lens and the hyperopia may be corrected through the lower portion of the lens. As described above, the progressive multifocal lens provides a convenience in which it is possible to focus on the object through single lens having a plurality of focal points, so that it is not necessary to wear various kinds of spectacles alternately as needed.

However, in the progressive multifocal lens, a boundary portion between one power of spectacle and different power of spectacle are unclear, so that when the object is focused through the boundary portion, a phenomenon in which the object appears blunt may occur. In addition, a user of a spectacle should be able to see the object correctly by aligning the line of sight with the center of the corresponding power of spectacle, otherwise, the user may need a period of adjustment after wearing the glasses, because dizziness may occur when the object is out of focus. There is an inconvenience that the user has to manually find a power of spectacle to be in focus among a plurality of powers of a corresponding spectacle. In addition, since the plurality of powers are spatially defined in single lens, the user has to adjust a focal length of the lens through any diopter mapping to a corresponding region of the lens, so that a view of the user may be narrowed.

### SUMMARY OF THE INVENTION

It is an object of the present disclosure to provide a variable-focus spectacle which does not require a wearer of a spectacle to select any one of a plurality of powers of spectacle manually or intentionally spatially divided and a view of the wearer is not narrowed.

Another object of the present disclosure is to provide a method of driving a variable focus spectacle having the above-described advantages.

According to an embodiment of the present disclosure, a variable focus spectacle includes a spectacle frame; a pair of lenses mounted on the spectacle frame, and having a plurality of refractive indexes that varies in sequential order by an applied voltage including at least two different power levels; and a refractive index adjuster for supplying the applied voltage to the pair of lenses, wherein the refractive indexes of the pair of lenses is varied at least twice per unit time according to the at least two different power levels.

In the embodiment of the present disclosure, the lens includes a first electrode; a second electrode; and a transparent optical switching layer disposed between the first electrode and the second electrode, and varying the refractive index of the lens according to a magnitude of the applied voltage from the refractive index adjuster through the first electrode and the second electrode. The transparent optical switching layer includes a ferroelectric material, and the ferroelectric material includes one of a barium-strontium-titanium oxide (Ba, Sr)TiO₃(BST), a strontium-titanium oxide (SrTiO₃), a barium-titanium oxide (BaTiO₃) and PLZT (Pb(La, Zr)TiO₃). At least one of the first electrode and the second electrode includes a transparent electrode, and the transparent electrode include one of a transparent conducting oxide (TCO), a silver nanowire, a carbon nanotube (CNT), a graphene, a conducting polymer, an indium tin oxide (ITO), a zinc oxide (ZnO), an indium zinc oxide (IZO) and an indium gallium zinc oxide (IGZO).

In the embodiment of the present disclosure, at least one lens includes a plurality of pixels, and the refractive index of each of the plurality of pixels is adjusted according to the applied voltage. A focal length of the lens is determined by a combination of a thickness of the lens and the variable refractive index of the lens.

In the embodiment of the present disclosure, the refractive index adjuster includes a rechargeable battery; a voltage converter converting an output voltage of the rechargeable battery to the at least two or more different power levels; and a power controller for controlling the at least two or more different power levels to be supplied to the pair of lenses in sequential order. The refractive index adjuster further comprises a switching unit for selecting any one of the at least two or more different power levels. The power controller controls the voltage converter such that the refractive index of the lens is mapped to any one of the at least two or more different power levels. The refractive index adjuster further comprises a display unit for displaying at least one of information related to a charge state of the rechargeable battery, a charge voltage of the rechargeable battery, information related to the power levels, and information related to the refractive index of the lens. The refractive index adjuster is detachably or attachable to the spectacle frame.

According to another embodiment of the present disclosure, a method of driving a variable focus spectacle includes supplying at least two or more different power levels to a pair of lenses; varying a plurality of refractive indexes of the pair of lenses sequentially in accordance with the at least two or more different power levels; and adjusting a focal distance of the pair of lenses according to the variable refractive index.

In the embodiment of the present disclosure, the method further includes generating the at least two or more different power levels using a voltage of a rechargeable battery.

In the embodiment of the present disclosure, the method further includes mapping the refractive index of the lens to one of the at least two different power levels according to a user input.

The refractive index of the lens is varied by a deformation of the lens based on a piezoelectric inversion effect. The refractive index of the lens may be varied based on any one of an ascending order, a descending order, and a random order. The refractive index of the at least one lens may be varied 30 to 60 times per a second. A first group of the refractive indexes may correspond to a focal length for a short distance of 10 cm or less, a second group of the refractive indexes may correspond to a focal length for a medium distance ranging from 10 cm to 1 m, and the third group of the refractive indexes may correspond to 1 m and the focal length for the long distance.

According to also another embodiment of the present disclosure, an optical lens includes a first electrode; a second electrode; and a transparent optical switching layer disposed between the first electrode and the second electrode, and varying a refractive index of the optical lens according to a magnitude of an applied voltage through the first electrode and the second electrode, wherein the transparent optical switching layer includes a ferroelectric material, and wherein the ferroelectric material includes one of a barium-strontium-titanium oxide (Ba, Sr)TiO₃(BST), a strontium-titanium oxide (SrTiO₃), a barium-titanium oxide (BaTiO₃) and PLZT (Pb(La, Zr)TiO₃). At least one of the first electrode and the second electrode includes a transparent electrode, and the transparent electrode include one of a transparent conducting oxide (TCO), a silver nanowire, a carbon nanotube (CNT), a graphene, a conducting polymer, an indium tin oxide (ITO), a zinc oxide (ZnO), an indium zinc oxide (IZO) and an indium gallium zinc oxide (IGZO).

According to an embodiment of the present disclosure, a pair of lenses having a plurality of refractive indexes that varies in sequential order by an applied voltage including at least two different power levels is included, so that it does not require a wearer of a spectacle to select any one of a plurality of powers of spectacle manually or intentionally and a view of the wearer is not narrowed.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a perspective view of a variable focus spectacle according to an embodiment of the present disclosure.

FIG. 2A is a cross-sectional view of a spectacle lens having a variable refractive index according to an embodiment of the present disclosure.

FIG. 2B is a front view of a spectacle lens having a pixel array structure viewed from a direction A according to the embodiment of the present disclosure.

FIGS. 3A to 3C are diagrams showing focal lengths varying according to a variable refractive index according to an embodiment of the present disclosure.

FIG. 4 is a detailed block diagram of a refractive index adjuster for supplying a power source for varying the refractive index of the spectacle lens according to the embodiment of the present disclosure.

FIG. 5 is a flow chart for a method of operating the variable focus spectacle according to an embodiment of the present disclosure.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Reference herein to a layer formed “on” a substrate or other layer refers to a layer formed directly on top of the substrate or other layer or to an intermediate layer or intermediate layers formed on the substrate or other layer. It will also be understood by those skilled in the art that structures or shapes that are “adjacent” to other structures or shapes may have portions that overlap or are disposed below the adjacent features.

In this specification, the relative terms, such as “below”, “above”, “upper”, “lower”, “horizontal”, and “vertical”, may be used to describe the relationship of one component, layer, or region to another component, layer, or region, as shown in the accompanying drawings. It is to be understood that these terms are intended to encompass not only the directions indicated in the figures, but also the other directions of the elements.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

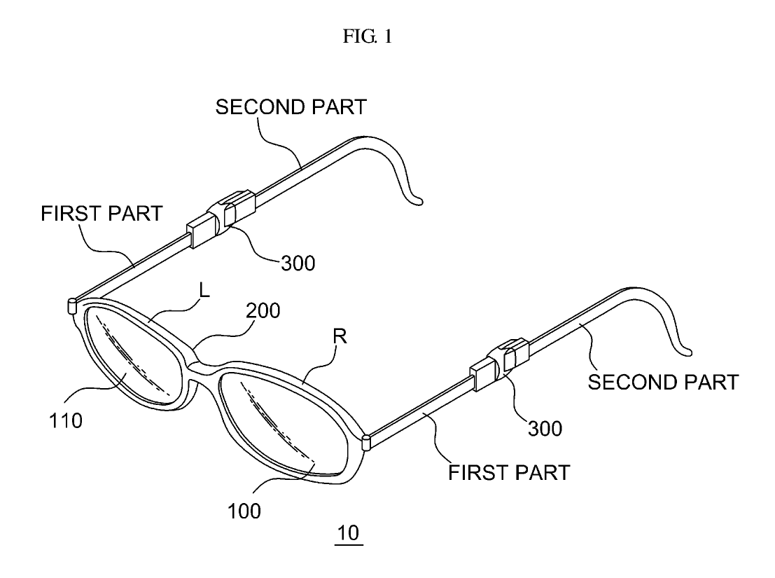

Referring to FIG. 1, the variable focus spectacle 10 include a pair of lenses 100 and 110, a spectacle frame 200 for fixing the pair of lenses 100, 110, and a refractive index adjuster 300 that may be integrated with the spectacle frame 200. The pair of lenses 100 and 110 are mounted or fixed to the left and right sides L and R of the spectacle frame 200 respectively, and the refractive index adjuster 300 is fixed to between the first and second parts of the spectacle frame 200, and may be structurally combined with the spectacle frame 200 to be integrated with the spectacle frame 200. An arrangement of the refractive index adjuster 300 is only one example, and are not limited to the present disclosure. For example, the refractive index adjuster 300 may be coupled to any portion of the spectacle frame 200 in various forms. Further, the shape of the spectacle frame 200 of the present disclosure is not limited to the frame shape shown in FIG. 1, but may be applied to various frame shapes.

The pair of lenses 100 and 110 have a plurality of refractive indexes that varies in sequential order by an applied voltage including at least two different power levels, and the refractive index adjuster 300 may supply the applied voltage to the pair of lenses 100 and 110. One refractive index adjuster 300 may be disposed on the spectacle frame 200 and may supply the applied voltage to the pair of lenses 100 and 110. In some embodiments, the two refractive index adjusters 300 are disposed on the spectacle frame 200, one of the two refractive index adjusters 300 may supply the applied voltage to the lens 100 and another of the two refractive index adjusters 300 may supply the applied voltage to the lens 110. Also, the refractive index adjuster 300 may be detached from the spectacle frame 200 and the detached refractive index adjuster 300 may be charged through an external charger (not shown). In some embodiments, the refractive index adjuster 300 may be configured such that when the variable-focus spectacle 10 may be coupled the external charger (not shown) without the need to detach the refractive index adjusters 300 from the spectacle frame 200.

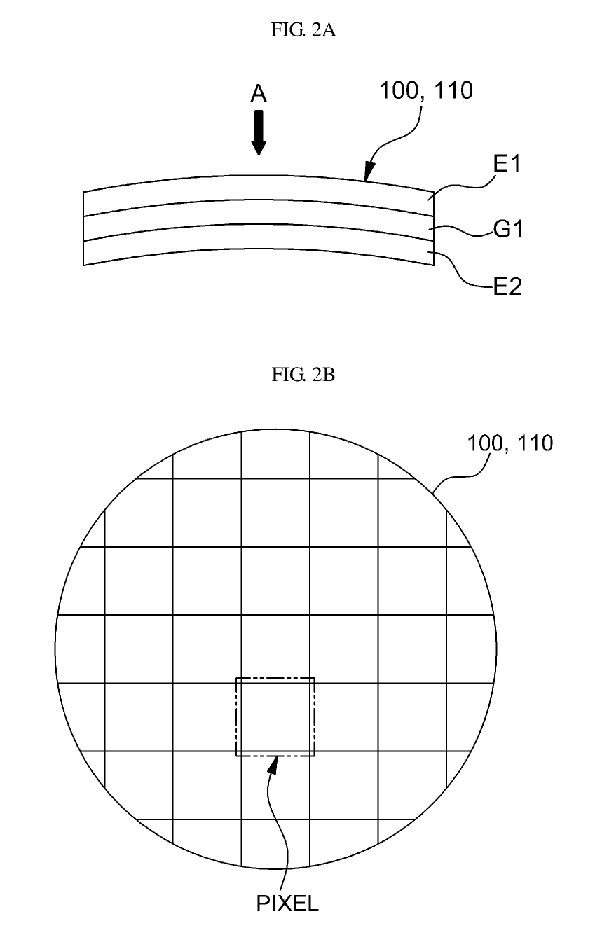

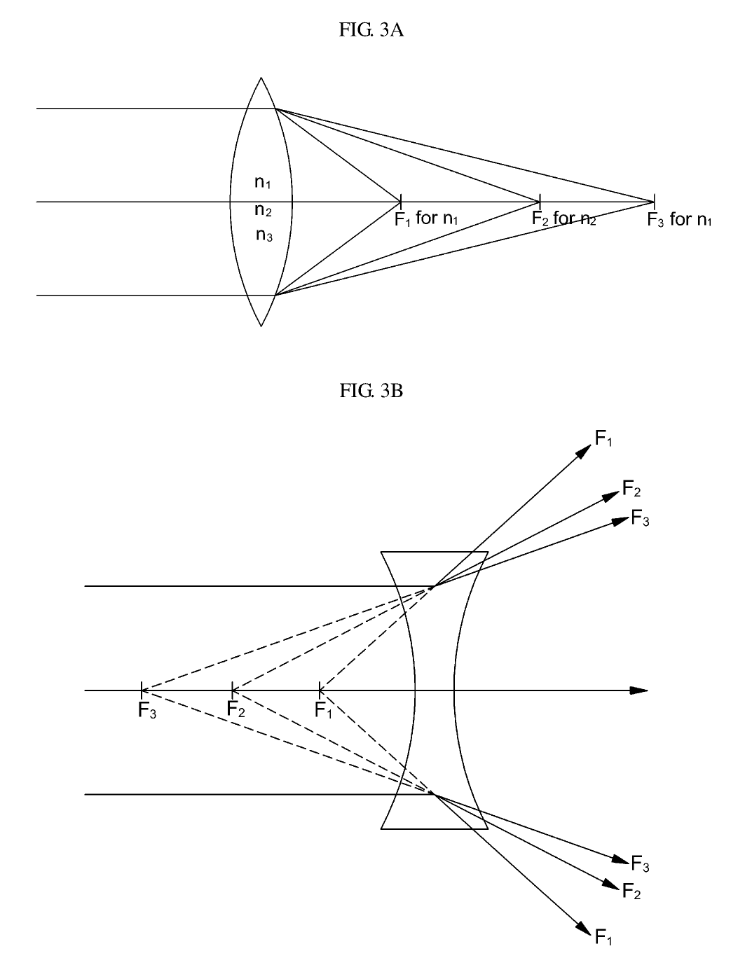

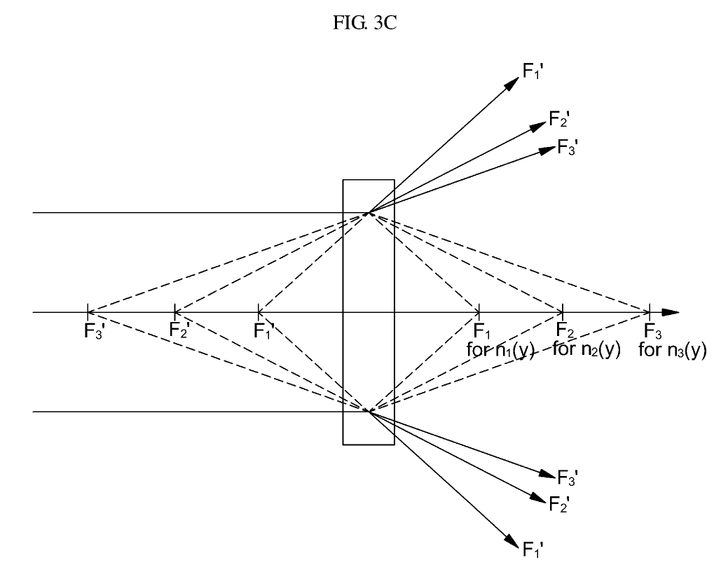

Here, the refractive index of the pair of lenses 100 and 110 may be changed in sequential order at least two times per unit time according to at least two or more different power levels. A detailed description of the lenses 100 and 110 will be described with reference to FIGS. 2A to 3C, and a detailed description of the refractive index adjuster 300 will be described with reference to FIG. 4.

FIG. 2A is a cross-sectional view of spectacle lenses 100 and 110 having a variable refractive index according to an embodiment of the present disclosure.

FIG. 2A, lenses 100 and 110 includes a first electrode E1, a second electrode E2 and a transparent optical switching layer G1 that are disposed between the first electrode E1 and the second electrode E2 and varies the refractive index in a time-sharing manner according to a magnitude of applied voltage from the refractive index adjuster 300 through the first electrode E1 and the second electrode E2. The transparent optical switching layer G1 includes a ferroelectric material, and the ferroelectric material may include one of a barium-strontium-titanium oxide ((Ba, Sr) TiO₃, BST), strontium-titanium oxide (SrTiO₃), a barium-titanium oxide (BaTiO₃), PZT (Pb(Zr, Ti)O₃) and PLZT (Pb(La, Zr)TiO₃). However, in the embodiment of the present disclosure, the transparent optical switching layer G1 is not limited to these, and any transparent material having refractive indexes adjustable by an electric field in the visible light region may be used.

At least one of the first electrode E1 and the second electrode E2 includes a transparent electrode. The transparent electrode may be one of a transparent conducting oxide (TCO), a silver nanowire, a carbon nanotube (CNT), graphenes, conducting polymers, indium tin oxide (ITO), zinc oxide (ZnO), indium zinc oxide (IZO), and indium gallium zinc Oxide (Indium gallium zinc oxide, IGZO). However, in the embodiment of the present disclosure, the first electrode E1 or the second electrode E2 is not limited thereto.

In another embodiment of the present disclosure, the transparent optical switching layer G1 disposed between the first electrode E1 and the second electrode E2 may be coated on a non-prescription lens or a glass. Therefore, when the first electrode E1, the second electrode E2, and the transparent optical switching layer G1 disposed between the first electrode E1 and the second electrode E2 are coated on a flat glass, since the refractive index of the flat glass is controlled by the transparent optical switching layer G1, the flat glass can also be used as a lens for a myopia, a nearsightedness, and a hyperopia.

As described above, the pair of lenses 100 and 110 of the variable-focus spectacle 10, unlike the conventional progressive multifocal lens which include a plurality of fixed powers of spectacle spatially different in one lens, may change a plurality of powers of spectacle sequentially by varying the refractive indexes of lens 100 or 110 in a time-varying manner. Therefore, since the variable-focus spectacle 10 according to the present disclosure do not have a boundary part between different powers of spectacle that are spatially separated from each other, there is no phenomenon that an object appears blurred when the object is focused through the boundary part. Further, when the variable-focus spectacle 10 of the present disclosure is worn, the refractive indexes of the variable-vision spectacle 10 varies in a time-varying manner, so that a wearer of spectacle does not have to manually or intentionally adjust a focus of the spectacle. In addition, since the power of the lens 100 or 110 is not divided into spaces in the variable-focus spectacle 10 of the present disclosure, the lens 100 or 110 offer larger field of view more than the conventional progressive multifocal lens.

Focal lengths of the variable-focus spectacle 10 change rapidly at a high speed even if the focal length (or the power of spectacles) is changed by a time-varying refractive index, so that the eye of the wearer of spectacle may not recognize that the power of spectacles changes. For example, even if a wearer of the spectacle continuously observes the focal length of the lens at a speed that an eye of the wearer cannot perceive (e.g., changes of 30 to 60 per second (30 Hz to 60 Hz)), regardless of a long distance, a middle distance or a short distance, it may look as if it were focused. This is the same principle as an interlaced scanning format of a TV in which the human eye is recognized as a single screen when the electron gun scans the CRT screen fast enough. In one embodiment of the invention, the short distance is 10 cm or less, the middle distance is 10 cm to 1 m, and the long distance may be 1 m or more. Therefore, even if the wearer of spectacle views the object at the long distance, the middle distance or the short distance, since the refraction index of the variable-focus spectacle 10 is changed from 30 times to 60 times per second in a time division manner, it may be perceived as the wearer of spectacle looks at the object through any fitted power of spectacle of the different variable powers of spectacle.

FIG. 2B is a front view of a lens of spectacle having a pixel array structure viewed from the direction A according to the embodiment of the present disclosure.

Referring to FIG. 2B, the lens 100 or 110 include a plurality of pixels, and the refractive index of each pixel may be adjusted according to the applied voltage of each pixel. For example, the applied voltage V₁ may be supplied to the first pixel, the applied voltage V₂ may be supplied to the second pixel, and the applied voltage Vₙ may be supplied to the n^{th} pixel. At this time, each pixel may be deformed by the applied voltage of each pixel. For example, the refractive index of each pixel can be varied by an inverse piezoelectric effect (or a piezoelectric converse effect) in which deformation occurs due to a voltage. The applied voltage V₁, V₂, V₃ are identical for each or are different for each.

Here, the refractive index for each pixel in the lenses 100 and 110 is determined by a thickness of the lenses 100 and 110 corresponding to each pixel and the applied voltage supplied to each pixel. Therefore, since the refractive index may be adjusted for each pixel, a plane lens having a constant thickness can function as a convex lens or a concave lens. As a result, the focal length of the lens 100 or 110 can be determined by the combination of the thicknesses of the lens 100 or 110 and the variable refractive index of each pixel. For example, n(x, y)=a (x2+y2)+b where n(x, y) denotes the refractive index at the point corresponding to the x, y coordinates, and a and b are constants, and if a, b>0, the refractive index becomes larger as the distance from the center of the spectacle lens increases, so that the same effect as that of the concave lens can be obtained. Similarly, when a, b>0 at n(x, y)=−a(x2+y2)+b, the refractive index becomes smaller as the distance from the center of the spectacle lens increases. This is because, regardless of the shape of the spectacle lens, various types of lenses can be utilized as spectacle lenses for correcting myopia and/or hyperopia without being limited by the type or form of the lens. For example, most of the spectacle lenses are used as one of a convex lens or a concave lens, but various types of lenses besides a convex lens or a concave lens can be utilized without being limited thereto.

FIGS. 3A to 3C are diagrams showing focal lengths varying according to a variable refractive index according to an embodiment of the present disclosure.

Referring to FIG. 3A, when the lens 100 or 110 are convex lenses, deformation occurs on a pixel-by-pixel basis by a power source (e.g. voltage or current) applied to the lenses 100 and 110, and thus the refractive index may be controlled. For example, the higher the applied voltage, the greater the refractive index can be. Another example, the higher the applied voltage, the smaller the refractive index can be. This can be determined depending on the material of the lens. When the applied voltage is V₁, the refractive index is n₁ and the focal distance may be adjusted to F₁ by the refractive index n₁, when the applied voltage is V₂, the refractive index is n₂ and the focal distance may be adjusted to F₂ by the refractive index n₂, and when the applied voltage is V₃, the refractive index is n₃ and the focal length may be adjusted to F₃ by the refractive index n₃. The focal distance F₁ is the focal length of a single lens having a refractive index of n₁, the focal distance F₂ is the focal length of a single lens having a refractive index of n₂, and the focal distance F₃ is a focal length of a single lens having a refractive index of n₃.

Referring to FIG. 3B, when the lens 100 or 110 are concave lenses, deformation occurs on a pixel-by-pixel basis by the power source applied to the lens 100 or 110, and the refractive index can be controlled. For example, the higher the applied voltage, the greater the refractive index can be. Another example, the higher the applied voltage, the smaller the refractive index can be. When the applied voltage is V₁, the refractive index is n₁ and the focal distance may be adjusted to F₁ by the refractive index n₁, when the applied voltage is V₂, the refractive index is n₂ and the focal distance may be adjusted to F₂ by the refractive index n₂, and when the applied voltage is V₃, the refractive index is n₃ and the focal length may be adjusted to F₃ by the refractive index n₃.

Referring to FIG. 3C, when the lens 100 or 110 is a plane lens, the lens 100 or 110 are deformed on a pixel-by-pixel basis by the power source, and the refractive index can be controlled. In addition, the plane lens can be driven in the same manner as the convex lens in FIG. 3A or the concave lens in FIG. 3B due to the variable refractive index of each pixel. For example, the focal length F₁ of the lens having the refractive index n₁ (y) is controlled by the n₁ (y), and the focal length F₂ of the lens having the refractive index n₂ (y) is controlled by the n₂ (y), and the focal length F₃ of the lens having a refractive index of n₃ (y) is controlled by the n₃ (y). At this time, F₁, F₂, and F₃ can be sequentially adjusted/switched at a high speed of 60 Hz or more.

The magnitudes of the voltages V₁, V₂, and V₃ supplied to the lens 100 or 110 to change the refractive index in FIGS. 3A to 3C may be sorted in descending order and ascending order. Alternatively, the magnitude of the voltages V₁, V₂, and V₃ may be sorted in random order.

In some embodiments, the applied voltages are repeatedly supplied in the order of V₁, V₂, and V₃ for each section in which the variable refractive index is repeated, or in each of the sections in which the variable refractive index is repeated, V₁, V₂, and V₃ in the first order, V₂, V₁, and V₃ in the second order, and V₃, V₂, and V₁ in the third order, respectively. The section where the variable refractive index is repeated has a range of 30 Hz to 60 Hz per second, which means that even if the refractive indexes are changed from 30 to 60 times per second, the user does not recognize the flicker phenomenon caused by the change from one refractive index to another refractive index.

Here, V₁ is a voltage source so that the lens has a refractive index corresponding to the focal length for the short range, V₂ is a voltage source so that the lens has a refractive index corresponding to the focal distance for the middle distance, and V₃ is a voltage source so that the lens has a refractive index corresponding to the focal length for the long range. However, the present disclosure is not limited to the voltages V₁, V₂, and V₃ or the focal distances for the short range, the middle distance and the long distance, and may be operated by dividing the focal distance by three or more steps or three or more steps.

FIG. 4 is a detailed block diagram of a refractive index adjuster 300 for supplying a power source for varying the refractive index of the spectacle lens 100 or 110 according to the embodiment of the present disclosure.

Referring to FIG. 4, the refractive index adjuster 300 includes a rechargeable battery 401, a voltage converter 402 for converting an output voltage V_{g} of the rechargeable battery 401 to at least two different power levels V₀, V₁, V₂, . . . and Vₙ, and a power controller 403 for controlling the at least two or more different power levels to be supplied to a pair of lenses 100 and 110.

The battery 401 may be a secondary battery, such as a lithium-ion battery, which is rechargeable by a battery charge (not shown). However, in the present disclosure, the battery 401 is not limited to a secondary battery. For example, the battery 401 may be a primary battery such as a mercury battery. The output voltage V_{g} of the battery may have a voltage within the range of from 5V to 15V.

The voltage converter 402 may be a voltage level shift for outputting a plurality of voltage levels V₀, V₁, V₂, . . . and Vₙ by raising or lowering the output voltage V_{g} according to a digital logic. However, in the present disclosure, the voltage converter 402 is not limited to the voltage level shift. For example, the voltage converting unit 402 may be a DC-DC converter.

The power controller 403 may determine the magnitudes and order of the applied voltages (for example, V₁, V₂, and V₃) to be supplied to the pair of lenses 100 and 110 during a period in which the variable refractive index is repeated, in order to vary the refractive index of the lenses 100 and 110 in a time-sharing manner, and control the voltage converter 402 and/or the battery 401 so that the applied voltages V₁, V₂, and V₃ are supplied to the lenses 100 and 110, according to the determined magnitudes of the applied voltages and order of the applied voltages. If the lenses 100 and 110 operate in a pixel array structure, the switching unit 404 performs a switching operation on a pixel-by-pixel basis, and the power controller 403 controls the switching unit 404 in pixels.

In some embodiments, the refractive index adjuster 300 may further include a switching unit 404 for selectively supplying the at least two different voltage levels to the lenses 100 and 110. For example, according to the control of the power controller 403, the switching unit 404 performs switching such that V₀ of the voltage levels V₀, V₁, V₂, . . . , Vₙ is supplied to the lenses 100 and 110 at first time point, V₁ of the voltage levels V₀, V₁, V₂, . . . , Vₙ is supplied to the lenses 100, 110 at second time point, . . . , Vₙ of the voltage levels V₀, V₁, V₂, . . . , Vₙ are supplied to the lenses 100 and 110 at n^{th} time point. Also, the index adjuster 300 may include a display unit 405 for displaying at least one of information related to a charge state of the battery 401, a charge voltage of the battery 401, the power level, and the refractive index of the lens. The display unit 405 may be a liquid crystal display (LCD). However, the present disclosure is not limited thereto. For example, the display unit 405 may be a light emitting diode (LED) or an organic light emitting diode (OLED). In addition, the power controller 403 may control the switching unit 404 to be fixed to any one of the at least two different power levels according to a user input. For example, the wearer of spectacle can select a desired refractive index among a plurality of variable refractive indexes using a user input interface (not shown), and focus on the selected refractive index. Accordingly, the power controller 403 can control the switching unit 404 so that the applied voltage corresponding to the selected refractive index can be supplied to the lenses 100 and 110 according to the input signal received through the user input interface.

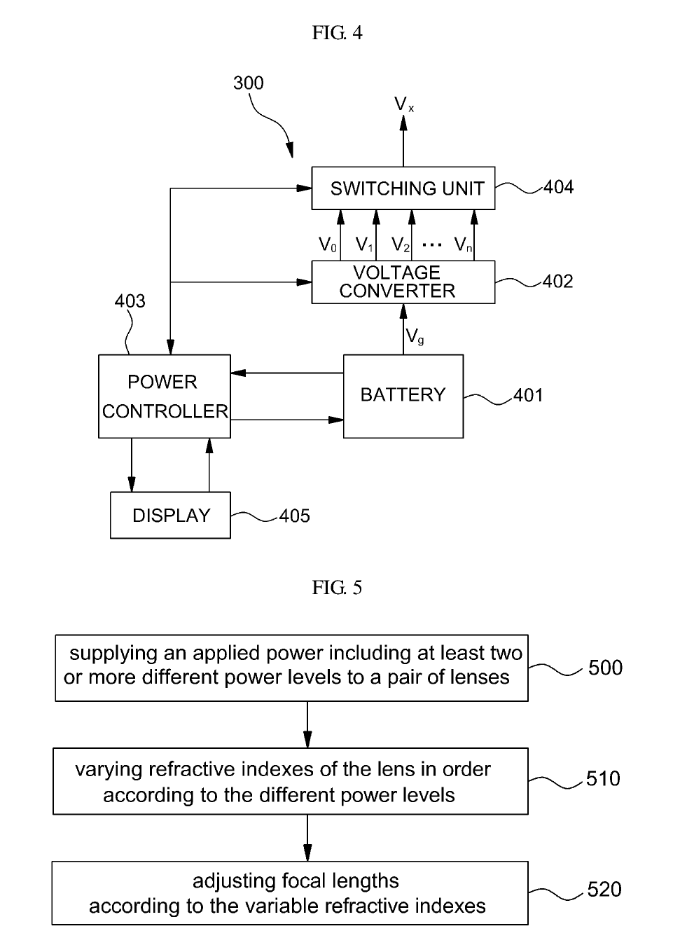

FIG. 5 is a flow chart for a method of operating the variable focus spectacle according to an embodiment of the present disclosure.

Referring to FIG. 5, the variable focus spectacle 10 supply an applied power including at least two or more different power levels to a pair of lenses 100 and 110 in step 500, and the refractive index of the lens is changed in order according to the different power levels in step 510, and the focal length is adjusted according to the variable refractive index in step 520. In some embodiments, the variable focus spectacle 10 may be configured to convert the voltage of the battery to at least two or more different power levels, and to fix the power level of any one of the at least two or more different power levels.

Unlike the conventional progressive multifocal lens, the pair of lenses 100 and 110 in the variable-focus spectacle 10 of the present disclosure are supplied with a plurality of different power levels in a time-sharing manner, so that the refractive indexes of the lenses 100 and 110 can be changed sequentially. Here, the refractive index of the lenses 100 and 110 can be varied by the deformation of the lenses 100 and 110 based on a piezoelectric converse effect. Further, the refractive indexes of the lenses 100 and 110 can be varied based on any one of ascending order, descending order and random order.

At this time, a flicker phenomenon may occur every time in which the refractive index is varied. However, the human eye may not be able to recognize flicker within the range of 30 Hz to 60 Hz per second. In one embodiment of the present disclosure, the refractive index of the lenses 100 and 110 varies from 30 to 60 times per second in a time-sharing manner, so that the user's eyes may not be able to recognize the flicker. For example, when three refractive indices n₁, n₂, and n₃ are changed within a range of 30 to 60 times per second in a predetermined order as shown in FIG. 3A, the user's eye is focused on any focal length corresponding to one of three refractive indices n₁, n₂, and n₃. That is, although the respective focal lengths corresponding to the refractive indices n₁, n₂, and n₃ are generated, the user's eye can view based on any one of the refractive indexes. Further, since the refractive indexes of the lenses 100 and 110 are sequentially varied, the wearer of spectacle does not need to manually or intentionally adjust the refractive index. The refractive index n₁ is a refractive index for adjusting a focal length at a short distance, the refractive index n₂ is a refractive index for adjusting a focal length at a middle distance, and the refractive index n₃ is a refractive index for adjusting a focal length at a long distance. The short distance is less than 40 cm, the middle distance is 40 cm to 4 m, and the long distance may be more than 4 m. However, in the present disclosure, the variable refractive index is not limited to the three refractive indices n₁, n₂ and n₃. For example, the number of variable refractive index per second may be two or three or more.

In the embodiment of the present disclosure, variable focus spectacle including lenses 100 and 110 having variable refractive indexes have been described by way of example, but the present disclosure is not limited thereto. For example, one of two plane lenses embody as a concave lens and another of two plane lenses embody as a convex lens by varying refractive indexes of two plane lenses, thereby utilizing as a lens of a telescope or a microscope. As another example, the lenses 100 and 110 having a variable refractive index may be utilized as lenses for headlamps of automobiles. For example, when the automobile is rotated on a curve road, the direction of the illumination can be controlled by adjusting the refractive index of the headlamp without mechanically adjusting the headlamp or the reflecting mirror. That is, the angle (or refractive index) of headlamps of automobiles can be adjusted up/down or left/right based on at least one of the movement of the handle, the vehicle speed, and the vehicle inclination.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A variable focus spectacle comprising:
a spectacle frame;
a pair of lenses mounted on the spectacle frame, and having a plurality of refractive indexes that varies in sequential order by an applied variable voltage selected from at least two different voltage levels; and
a refractive index adjuster for supplying the applied variable voltage to the pair of lenses,
wherein the refractive indexes of the pair of lenses is varied at least twice per unit time according to the at least two different voltage levels.

2. The variable focus spectacle of claim 1, wherein the lens comprising:
a first electrode;
a second electrode; and
a transparent optical switching layer disposed between the first electrode and the second electrode, and varying the refractive index of the lens according to a magnitude of the applied variable voltage supplied from the refractive index adjuster through the first electrode and the second electrode.

3. The variable focus spectacle of claim 2, wherein the transparent optical switching layer includes a ferroelectric material,
wherein the ferroelectric material includes one of a barium-strontium-titanium oxide (Ba, Sr)TiO₃(BST), a strontium-titanium oxide (SrTiO₃), a barium-titanium oxide (BaTiO₃) and PLZT (Pb(La, Zr)TiO₃).

4. The variable focus spectacle of claim 2, wherein at least one of the first electrode and the second electrode includes a transparent electrode,
wherein the transparent electrode includes one of a transparent conducting oxide (TCO), a silver nanowire, a carbon nanotube (CNT), a graphene, a conducting polymer, an indium tin oxide (ITO), a zinc oxide (ZnO), an indium zinc oxide (IZO) and an indium gallium zinc oxide (IGZO).

5. The variable focus spectacle of claim 1, wherein at least one lens includes a plurality of pixels,
wherein the refractive index of each of the plurality of pixels is adjusted according to the applied voltage.

6. The variable focus spectacle of claim 1, wherein a focal length of the lens is determined by a combination of a thickness of the lens and the variable refractive index of the lens.

7. The variable focus spectacle of claim 1, wherein the refractive index adjuster comprising:
a rechargeable battery;
a voltage converter converting an output voltage of the rechargeable battery to the at least two or more different power levels; and
a power controller for controlling the at least two or more different power levels to be supplied to the pair of lenses in sequential order.

8. The variable focus spectacle of claim 7, further comprising:
a switching unit for selecting any one of the at least two or more different power levels.

9. The variable focus spectacle of claim 7, wherein the power controller controls the voltage converter such that the refractive index of the lens is mapped to any one of the at least two or more different power levels.

10. The variable focus spectacle of claim 7, further comprising:
a display unit for displaying at least one of information related to a charge state of the rechargeable battery, a charge voltage of the rechargeable battery, information related to the power levels, and information related to the refractive index of the lens.

11. The variable focus spectacle of claim 1, wherein the refractive index adjuster is detachably or attachable to the spectacle frame.

12. A method of driving a variable focus spectacle comprising:
supplying at least two or more different power levels to a pair of lenses;
varying a plurality of refractive indexes of the pair of lenses sequentially in accordance with the at least two or more different power levels; and
adjusting a focal distance of the pair of lenses according to the variable refractive index.

13. The method of claim 12, further comprising:
generating the at least two or more different power levels using a voltage of a rechargeable battery.

14. The method of claim 12, further comprising:
mapping the refractive index of the lens to one of the at least two different power levels according to a user input.

15. The method of claim 12, wherein the refractive index of the lens is varied by a deformation of the lens based on a piezoelectric adverse effect.

16. The method of claim 12, wherein the refractive index of the lens is varied based on any one of an ascending order, a descending order, and a random order.

17. The method of claim 13, wherein the refractive index of the at least one lens is varied 30 to 60 times per second.

18. The method of claim 13, wherein a first group of the refractive indexes corresponds to a focal length for a short distance of 10 cm or less, a second group of the refractive indexes corresponds to a focal length for a medium distance ranging from 10 cm to 1 m, and the third group of the refractive indexes corresponds to 1 m and the focal length for the long distance.

19. An optical lens comprising:
a first electrode;
a second electrode; and
a transparent optical switching layer disposed between the first electrode and the second electrode, and varying a refractive index of the optical lens according to a magnitude of an applied voltage through the first electrode and the second electrode,
wherein the transparent optical switching layer includes a ferroelectric material,
wherein the ferroelectric material includes one of a barium-strontium-titanium oxide (Ba, Sr)TiO₃(BST), a strontium-titanium oxide (SrTiO₃), a barium-titanium oxide (BaTiO₃) and PLZT (Pb(La, Zr)TiO₃).

20. optical lens of claim 19, wherein at least one of the first electrode and the second electrode includes a transparent electrode,
wherein the transparent electrode includes one of a transparent conducting oxide (TCO), a silver nanowire, a carbon nanotube (CNT), a graphene, a conducting polymer, an indium tin oxide (ITO), a zinc oxide (ZnO), an indium zinc oxide (IZO) and an indium gallium zinc oxide (IGZO).
